(19) United States
(12) Patent Application Publication
(10) Pub. No.: US 2014/0129587 A1
(43) Pub. Date: May 8, 2014

(54) APPROACH TO DISTRIBUTED CONTROL SYSTEMS GRAPHICS DISPLAY FOR PROCESS CONTROL SYSTEMS

(71) Applicant: Mahesh Subramaniam, Bangalore (IN)

(72) Inventor: Mahesh Subramaniam, Bangalore (IN)

(21) Appl. No.: 13/670,471

(22) Filed: Nov. 7, 2012

(51) Int. Cl. G06F 17/30; G09G 5/34

(52) U.S. Cl. CPC G06F 17/30106; G09G 5/34
USPC 707/769

(57) ABSTRACT

This embodiment relates to Distributed Control Systems graphics display for better viewing and process control. DCS graphics display presents the entire plant process as a scrollable application. Data files, describing the equipments, pipes, and distances between them are used as inputs to create graphic display. A rendering engine converts the input data files into viewable graphic display with static and dynamic elements shown. A facility is provided for Users/operators to query process condition on graphic display. The results of query are published as list and marked in Graphic display. The rendering engine displays the graphic, at the maximum zoom level, so as to include all results of query.

### TECHNICAL FIELD

This embodiment relates to in plant process and in particular to a new approach in graphics display of Distributed Control Systems for enhanced and ease of monitoring and control.

### BACKGROUND

Process plant operators use DCS-Distributed Control Systems to monitor and control the plant operation. Graphics display current process values; alarms and process flow along equipments and pipes.

Currently, in most DCS graphics based systems, each of graphic display file represents a section of plant and links are provided at the frame boundary of page to call the next page. The operators quite often have to monitor parameters across different pages, as they are physically wide apart and not available on a single graphic page. Either they traverse the pages using the links, provided on ends to move to next graphic display or have them in different screens. Also, there are dedicated keys on keyboard to invoke the graphic display—one key for each graphic display. There is no scrolling feature from one section of plant to another, after invoking one graphics display page.

There is no interactive query possible on graphics displays with current generation of control systems. An operator wanting to know ‘All Emergency alarms in a Unit’ cannot get a direct response from the graphic display. If a technician wants to query on pumps performing below their designed capacity' there will be no direct response from graphic display. Even if technician were to find the list of underperforming pumps through other means, no single graphic display would indicate their locations in process plant

Most of the current generation DCS graphics based system make use of static graphic pages and hence cannot be easily ported to another platform like PDA/Smart phones. The Graphics, usually built using proprietary software have to be transformed using relevant tools to make it compatible with other devices. So is the case when control systems are revamped and legacy systems are replaced with latest systems, the graphics need to be created from scratch.

### SUMMARY

In view of the foregoing, an embodiment herein provides a distributed control system (DCS) graphics system in a plant. The DCS graphics system provides an interactive query services to users. Data files are used for describing inter-connection properties of all equipments and instruments of the plant . A real time database accesses all real time process values and also keeps an archive of previous values. A rendering engine uses data files and results from real time database for creating a graphics file which is shown on the display. The display allows users to scroll through pages and also zoom down for better viewing.

Embodiments further disclose a method for providing interactive query services to users in a distributed control system (DCS) graphics system in a plant. The method allows users to create query-using graphics displayed. This query is sent to a real time database, which provides the appropriate results to the user display and a rendering engine. The rendering engine then uses these results and stored data files to create a graphic file as per users query. The graphics file is them displayed on the user screen.

These and other aspects of the embodiments herein will be better appreciated and understood when considered in conjunction with the following description and the accompanying drawings.

### BRIEF DESCRIPTION OF THE FIGURES

The embodiments herein will be better understood from the following detailed description with reference to the drawings, in which:

FIG. 1 illustrates a block diagram of the rendering engine, the heart of this embodiment, with its associated inputs and outputs, according to the embodiments disclosed herein;

FIG. 2 illustrates a block diagram showing components of the rendering engine, according to the embodiments disclosed herein;

FIG. 3 is a sample section of process flow diagram or can be considered as sample graphic display, according to the embodiments disclosed herein;

FIG. 4 illustrates an example of syntax used for a creating a data file for an equipment in a plant process, according to the embodiments disclosed herein;

FIG. 5 is a sample graphic display with user query 501, query result 502 and process graphics 503, displaying the equipments and process values on that section of plant, according to the embodiments disclosed herein.

### DETAILED DESCRIPTION OF EMBODIMENTS

The embodiments herein, the various features, and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

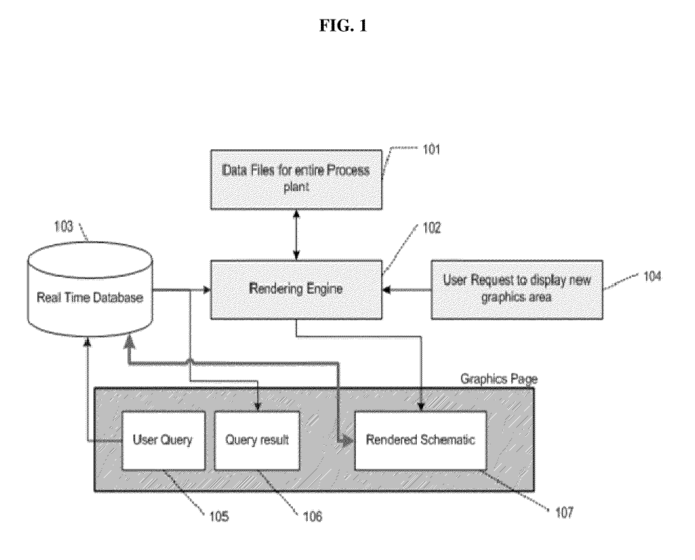

FIG. 1 illustrates a block diagram of the rendering engine with its associated inputs and outputs, according to the embodiments disclosed herein. The main blocks are a rendering engine 102, an input data file 101, a real time database to query dynamic data 103, and the graphic display which includes the user query—105, the query result 106 and the generated graphic display 107. The rendering engine 102 forms the heart of this embodiment, process the input data file and converts into a viewable graphic page 107. The real time database 103 is storehouse or repository for all dynamic data or in other words the real time data of plant. The real time database 103 may also be connected to multiple sensors, which alert the database 103 and the entire system of an emergency situation in the plant. The Data file 101 will have the co-ordinates of all equipments and pipes in plant. The scrolling feature to display the graphics as ‘boundary less’ is made possible by using data file as input for graphics. The user query 105 is also from the graphic display, a query created by operator related to plant processes. Based on the query, the real time database 103 provides the results to the rendering engine 103, and to graphic display. In the graphic display, the query result 106 appears as list on left partition of graphics display. The query result 106 sent to rendering engine is displayed as graphic page—covering all items in list marked as placeholders on graphic. The rendering engine 102 processes the results received from the real time database 103 and construct a graphic file covering all the listed item of results with those marked as place holders on the rendered graphics display. The rendering engine 102 displays the graphics page to the required zoom level so all the listed items are covered in a single display. The Operator can focus on a section of the plant to the required zoom level and operate from thereon. By zooming up, the operator can monitor the crucial parameters of entire unit in a single page. By zooming down, the operator gets to view more process values. This structure would also fully comply with recommendation of the ASM consortium (a group of control systems OEM and End users reviewing abnormal situation management in plants). ASM recommends plant graphics to be divided into 3 levels:

Level 1—being the Process Area Overview displays—overview of entire span of Operations;

Level 2—Process Unit overview displays—enough information to control plant under normal conditions;

Level 3—Detail Display to the extent possible

Once the graphic page is rendered, the process values are regularly updated by real time engine. The static graphics is defined in a data file. The data file will have the co-ordinates of all equipments and pipes in plant. With a data file as input file, the rendering engine 102 can be extended to generate graphic files compatible in other platforms—it could Web based graphics or hand held device (wherein the handheld device may be a tablet, PDA, smart phones and so on), irrespective of operating system. Also when changes are made to the plant, like an additional transmitter added or a bypass pipe laid, the data file will be modified and updated and not the individual graphic displays.

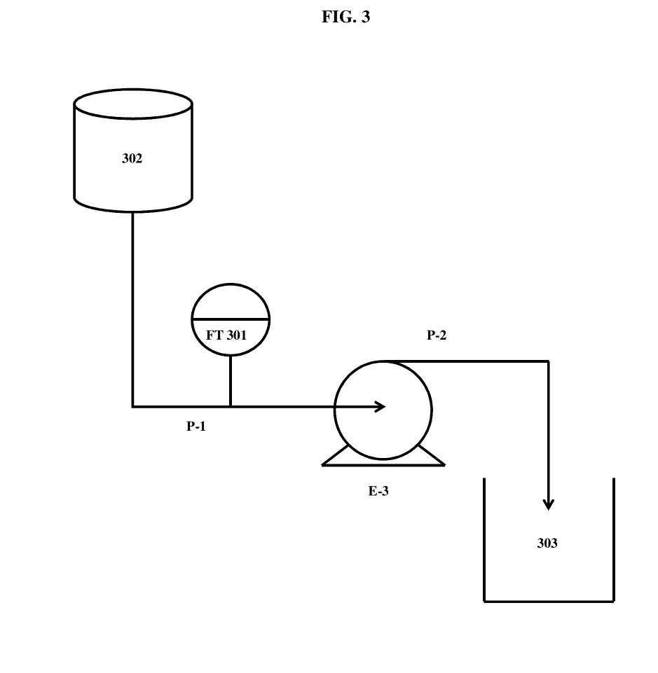

Consider an example as shown in FIG. 3. Co-ordinates are used to define Vessel 302 or pipe P-1 boundaries. The distance of P-1 will also be defined. Each equipment and Process parameter will be defined as objects. The objects parameters will have co-ordinates, distances, and the equipment or pipe preceding and succeeding it and so on. In this way, the entire plant layout will be available as data file.

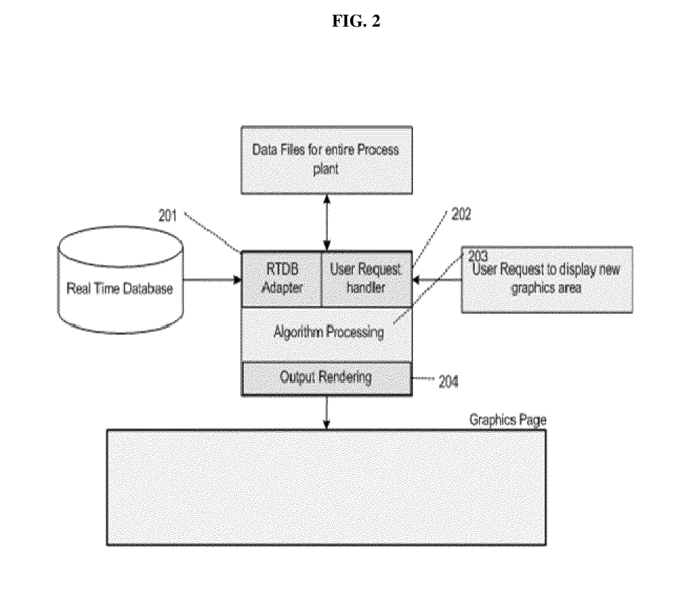

FIG. 2 illustrates a block diagram of showing components of the rendering engine, according to the embodiments disclosed herein. The rendering engine uses the data file to convert to viewable graphic presentation. The Rendering engine has an adapter, 201 that accept data from a real time database. The output of interactive query is sent to rendering engine and engines constructs the graphic page to include query output in the rendered display. Querying a list of emergency alarms in the plant—would present the graphics focused on those parameters in alarms at required zoom level. User request handler, 202, handles request from user to display a different section of plant. The User request would contain the co-ordinates as attributes for rendering engine to decide on boundaries of graphic display to be shown. The Algorithm processing, 203, process the input file and creates the static file image of graphics. The rendering engine creates tiles for different zoom levels (i.e., the entire plant would be available as single tile at the lowest zoom level, and in 4 tiles at the next zoom level and so on). The tiles would be compiled on the fly as operator scrolls or alternatively could be cached in local machine. In the Output rendering, 204, the dynamic elements are added and finally rendered as viewable graphic display for monitor & control.

FIG. 3 is sample section of a typical process graphics. The figure shows liquid being pumped from one vessel, 302, to another, 303, using a Pump E-3 on pipes P-1 and P-2.

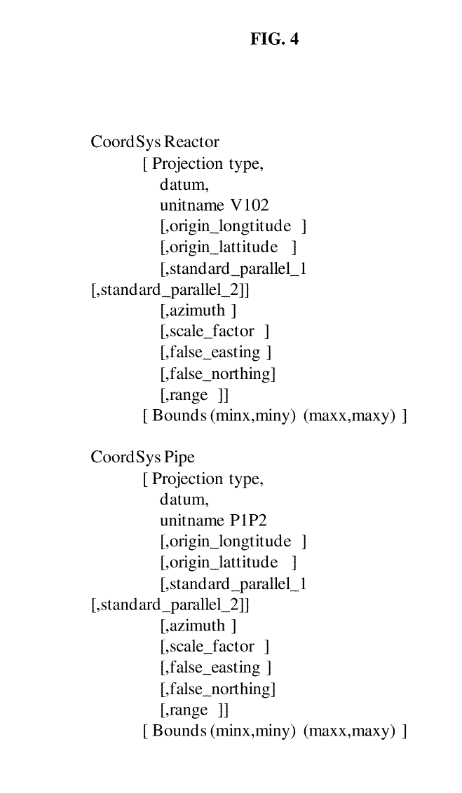

FIG. 4 illustrates an example of syntax used for a creating a data file for equipments in a plant process, according to the embodiments disclosed herein. The Data file will have the co-ordinates of all equipments and pipes in plant. A reactor or distillation column or process pipes will have co-ordinates, latitude, longitude, starting origin, and destination to define its boundaries.

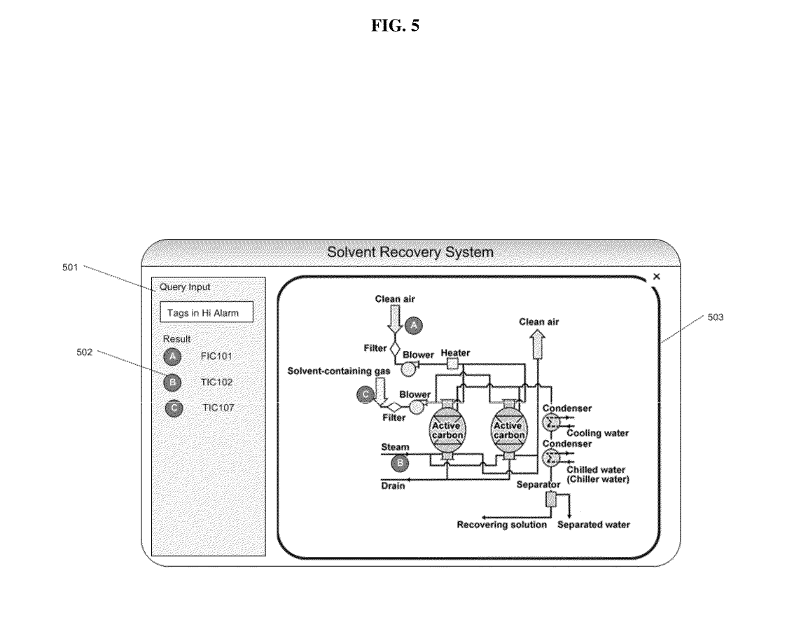

FIG. 5 is tangible representation of part of this idea. The User query, 501, is directed to real time database and result of query is displayed as Results, 502. The query result from real time database is also sent to rendering engine to construct the graphic display so all results of query results are included on graphic display. Rendering engine processes the inputs from real time database and renders the graphic display with results marked as placeholders—displayed as A, B, C. in circles

The DCS graphics display system can also find the shortest path between equipments present in the plant. On querying, the user output can display the shortest path. Though this feature is part of specialized software like Oil movement application, this can be implemented as Data files are used as input for graphics can provide the information.

The overall computing environment can be composed of multiple homogeneous systems that are part of Distributed control systems. There are no changes required to hardware of control systems. Referring now to the drawings, and more particularly to FIGS. 1 through 5 where similar reference characters denote corresponding features consistently throughout the figures, there are shown embodiments. The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and is not limiting. Therefore, while the embodiments herein have been described in terms of preferred embodiments, those skilled in the art will recognize that the embodiments herein can be practiced with modification within the spirit and scope of the claims as described herein.

We claim:

1. A distributed control system (DCS) graphics system in a plant for providing interactive query services to users, said system comprising of:
a plurality of data files for describing plant equipments, process and properties;
a real time database that access all real time process values and has archive of previous values;
a rendering engine that would use input data files for processing and render viewable graphics displays; and
a graphic display screen for displaying real time data to users, wherein said displays are scrollable and zoom able image.

2. The DCS graphics system of claim 1, wherein said rendering engine processes query from user using associated data file and renders the graphic file for operator viewing .

3. The DCS graphics system of claim 1, wherein said data file describes inter-connection properties of all equipments and instruments of the plant.

4. The DCS graphics system of claim 1, wherein said display creates a boundary less view using a scrolling feature.

5. A method for providing interactive query services to users in a distributed control system (DCS) graphics system in a plant, said method comprising of:
displaying User creating query-using graphics;
directing the query by the display to a real-time database;
sending results by the real-time database to a rendering engine;
processing results by the rendering engine from real-time database; and
constructing graphics file for the graphic display.
